(19) United States
(12) Patent Application Publication
(10) Pub. No.: US 2018/0330566 A1
(43) Pub. Date: Nov. 15, 2018

(54) AUTOMATED VENDING MACHINES FOR MAKING JUICE PRODUCTS AND COTTON CANDY

(71) Applicant: RobotsFoods Corporation, Owings Mills, MD (US)

(72) Inventor: Mikalai SAKHNO, Moscow (RU)

(73) Assignee: RobotsFoods Corporation, Owings Mills, MD (US)

(21) Appl. No.: 15/979,841

(22) Filed: May 15, 2018

Related U.S. Application Data
(60) Provisional application No. 62/506,059, filed on May 15, 2017.

(51) Int. Cl. G07F 13/06; B25J 18/00; B25J 15/00; B25J 11/00; A23N 1/00; A23L 2/04; G06Q 20/18; G06Q 20/34

(52) U.S. Cl. CPC G07F 13/065; B25J 18/00; B25J 15/0052; B25J 11/0045; A23V 2002/00; A23L 2/04; G06Q 20/18; G06Q 20/352; Y10S 901/28; A23N 1/00

(57) ABSTRACT

An apparatus for making and vending juice products and a method for making and vending juice products are disclosed. The invention comprises one or more robotic manipulator arms which move automatically to produce a final product based on an algorithm contained within a program based on an order made by a consumer. The robotic manipulator arms comprise hands or other means for grabbing and transferring materials. The housing of the apparatus comprises solid transparent surfaces such that the interior of the apparatus comprising the robotic manipulator arms is visible from an exterior perspective. The robotic manipulator arms perform actions such as transferring produce from storage to juicer, transferring beverage containers from dispensers to juicers, combining juices, and delivering a finished product to a consumer. An apparatus for making and vending cotton candy products and a method for making and vending cotton candy products are also disclosed.

### CROSS-REFERENCE TO RELATED APPLICATIONS

This patent application claims priority to U.S. Provisional Patent App. Ser. No. 62/506,059, filed May 15, 2017, which is incorporated fully herein by reference.

### FIELD OF THE INVENTION

This invention relates to automated methods for making cotton candy and fruit juice products and automated apparatuses for making and vending cotton candy and fruit juice products.

### BACKGROUND OF THE INVENTION

There are many types of vending machines in the market, but vending machines designated for dispensing drinks that include fruit and vegetable parts which are made instantaneously by a visible robot within the machine, are not yet available. Similar vending machines for making cotton candy of various shapes and sizes are also not yet available.

U.S. Pat. No. 4,759,471 suggests a process for preparing fruit juice beverages containing solid matter such as pulp materials whereas this process includes a deaeration treatment to remove air bubbles occluded in the fruit juice. Prior art vending machines also provide for automatic dispensers for juice extracted from a single kind of fruit or vegetable, for example, vending machines that provide citrus fruit juices which press or grind a desired number of citrus fruits at the time of serving. But prior art vending machines are designated for a single produce only, mostly citrus fruits, from which they extract the natural juice. Furthermore, prior art machines enclose the juice-making process without an opportunity for a consumer to view the process. Such machines are described in U.S. Pat. Nos. 4,974,505, 5,544,572, 5,743,176, and 6,234,071, among others.

There are also non-vending machines which extract juice from just about any kind of fruit or vegetable: carrots, oranges, apples, grapes, citrus, roots, tomatoes, pears, and so on, as well as grass and other greens. These machines can separate the juice from the solid part of the fruit or vegetable. Such non-vending machines are described in U.S. Pat. Nos. 6,968,777, 6,862,982, 6,397,736, and 6,609,455, among others.

Machines for making cotton candy are generally known today. There are various types of cotton candy making machines on the market, such as a hand-operating type cotton candy making machine to be used at a temporary store at a festival and an automatically-operated cotton candy vending machine to be provided as a permanent machine at a store. The conventional automatic cotton candy vending machine (hereinafter, also simply referred to as a cotton candy making machine), for example, comprises a means for supplying granular sugar as a raw material, a rotary pot that ejects floss-like threaded sugar therefrom by heating the predetermined amount of the raw material supplied from the sugar-supplying means, and a means for positioning a floss taking-up stick (hereinafter, also simply referred to as a stick) on which floss-like threaded sugar is wound. In general, the rotary pot is coaxially placed on the inside of the basin and their openings are directed upward, so that they are supported and rotated by any devices provided below their backs. In this case, the raw material (i.e., granular sugar) is supplied into the inside of the rotary pot through a chute from above.

### SUMMARY OF THE INVENTION

The present invention comprises machines for making and vending juice products, machines for making and vending cotton candy products, and methods for making and vending juice products and cotton candy products.

The machines for making and vending juice products comprise a see-through machine comprising storing tanks for holding fruits and vegetables, juicers, peeling devices, container dispensers, containers, an automatic cleaning system, and robotic manipulator arms with hands. The robotic arms transfer produce from storing tank to juicer and transfer containers from dispenser to juicer to the delivery platform and output window. Via a user interface, a consumer inputs their desired product and the algorithm of the control system controls the movement of the robot. The effect is an entertaining and quality-proof system for making and vending juice products. Methods for employing the machine for making and vending juice products are also disclosed.

The machines for making and vending cotton candy comprise a see-through machine comprising stick dispensers, a cotton candy making apparatus, press molds and other shaping mechanisms, and robotic manipulator arms with means for holding a stick. The robotic arms utilize the cotton candy making apparatus and transfer the final product to the delivery window. Via user interface, a consumer inputs their desired product and the algorithm of the control system controls the movement of the robot. The effect is an entertaining and quality-proof system for making and vending cotton candy products. Methods for employing the machine for making and vending cotton candy are also disclosed.

### BRIEF DESCRIPTION OF THE DRAWINGS

FIG. 1 shows an exemplary juice product vending machine according to the present invention.

FIG. 2 shows an exemplary cotton candy vending machine according to the present invention.

FIG. 3 is a flow chart of an exemplary automated method for making juice products according to the present invention.

FIG. 4 is a flow chart of an exemplary automated method for making cotton candy according to the present invention.

FIG. 5 shows exemplary products produced by the cotton candy vending machine of the present invention.

FIG. 6 shows another exemplary cotton candy vending machine according to the present invention.

### DETAILED DESCRIPTION OF THE PREFERRED EMBODIMENT

Juice Vending Machine.

There exists a need for a vending machine that can transparently create and also provide, in an entertaining manner, a user with a drink which contains fruits, vegetables, or a mixture of fruits and/or vegetables. Making drinks/shakes that are freshly produced from multiple produce products, provides drinks/shakes enriched with multiple dietary ingredients, such as vitamins, that cannot be provided from a single fruit or vegetable. Also, preparing the drink in a visibly automated yet human-like fashion creates both trust in the consumer of a fresh product as well as a visual entertainment while the juice product is being made.

The present invention comprises an automated machine or process for the production and vending of juice products. Exemplary juice products include but are not limited to fruit juices and vegetable juices.

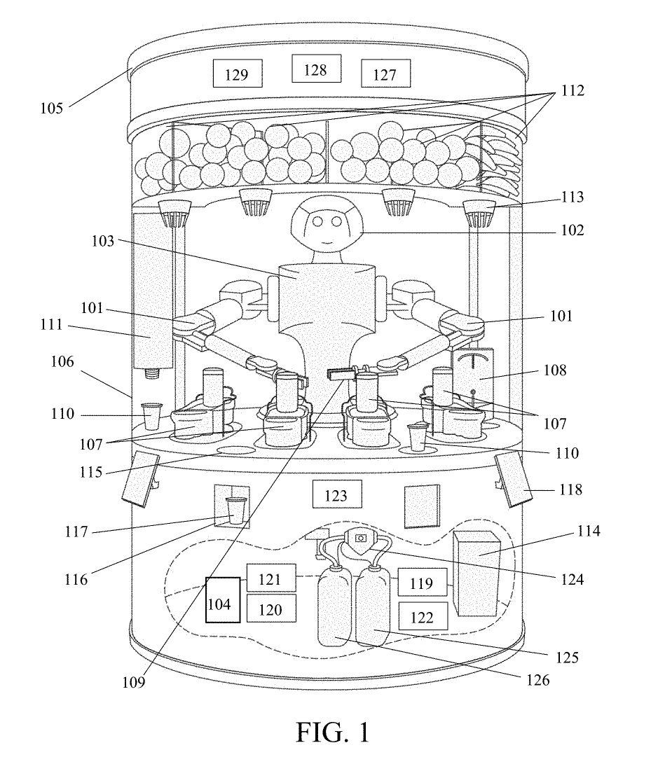

The working mechanism of the device comprises an apparatus for making juice products from whole fruits or vegetables. The apparatus may be of any shape and size and may have any technical features. Referring now to FIG. 1, the working mechanism further comprises one or more robotic manipulator arms 101 which are used to create (e.g., blend, mix) various fruit juices, vegetable juices, or combined juice products. Preferably, the device comprises two (or more) robotic manipulator arms 101. The robotic manipulator arms simulate the action of human arms and hands, as if a human was performing the procedure of making juice from whole fruits and vegetables. The robotic manipulator arm(s) may be fixed to the device and/or designed to resemble a robot with a head 102, body 103, and legs (not shown). The robot is connected to a computer/processor 104 which instructs the movements of the robot such that various juice products may be created within the machine. The robot is freely moving (i.e. unconnected to any structure such that the arms are moveable in any direction and bendable at any degree). The apparatus for making juice products and the robotic manipulator arm(s) are positioned inside a housing 105 which forms the outside of the vending machine.

The housing of the vending machine is made of high-strength material (e.g., composite, plastic, metal, etc.) suitable for sustainable operation. The housing comprises four walls, each wall comprising a solid transparent surface 106 (e.g., windows) which form a visible open area within the vending machine. The right and/or left walls of the vending machine comprise means for opening/closing the vending machine to access the interior open area for cleaning, maintenance, refilling, and modifying the interior of the machine, when desired.

The interior of the machine further comprises one or more removable and replaceable juicers 107, said juicers 107 making freshly squeezed or ground juice products. The interior of the machine also comprises one or more removeable/replaceable peeling devices 108 for peeling the skin of fruits and vegetables.

The machine further comprises one or more (preferably two) robot manipulator arms 101 with hands 109. The robot manipulators arms 101 with hands 109 are employed to grab/move fruits and vegetables, peel the fruits and vegetables, move containers 110 (e.g., glasses, cups, etc.), and perform other human-like vending actions. The carrying capacity of each manipulator arm 101 with hand 109 is up to 10 kg. It is noted that via the manipulator arms, the juice product is made significantly faster than if a human were performing the same process. Thus, significantly more consumers can be served in the same amount of time. Additionally, the manipulator arms 101 may perform entertaining maneuvers while transferring produce or juice product from one position to another. The manipulator arms 101 with hands 109 have 2-7 degrees of freedom, allowing for the twisting, turning, and other maneuvering of the produce and/or juice product in manners which are impossible to be performed by a human arm. In one embodiment, for example, each hand 109 has 5 degrees of freedom, and each hand 109 is fixed to the robot body which also rotates in a circular manner (at least one additional degree of freedom from the rotating body). The manipulator arms 101 and hands 109 are moved via stepper motors with feedback, wherein the joints of the manipulator arms 101 and hands 109 are driven in the absence of gears (e.g., without planetary or wave gears). Each hand 109 of a manipulator arm 101 (i.e., via the connection between the arm 101 and the hand 109) has an orbital velocity of up to 50 meters per minute. The manipulator arms 101 with hands 109 are each manufactured via methods for 3D printing.

The interior of the vending machine further comprises a beverage container dispenser 111, which stores containers of varying size and allows for the robot manipulator arms to grab a desired container 110 based on a consumer order. Several beverage container dispensers may be installed.

The interior of the vending machine further comprises one or more storing tanks 112, where whole fruit and whole vegetables are stored until they are accessed by a robot manipulator arm 101. In some embodiments, the accessible whole fruit or vegetable is located at the bottom of the storing tank through an opening 113 (as shown in FIG. 1). The storing tanks 112 each contain a specific whole fruit or vegetable. The storing tanks 112 may vary in numbers (e.g., from 1 to 10 total tanks per machine) and maintain a cool temperature (similar to a refrigerator temperature) in order to maintain the flavor of each fruit and vegetable.

The robot manipulator arms 101 with hands 109 may be coupled to a robot body in order to resemble a human operator. The body may comprise a head portion 102, chest/abdomen 103, and other limbs (i.e. lower limbs) which are visible through the transparent portions of the walls. The head portion 102 of the body may comprise a screen, the screen comprising a virtual face of a robot, an animated face, or a face resembling a human being. In other embodiments, the screen may comprise a video or a photographic display instead of or in addition to a virtual face. The head portion 102 may be moveable, rotatable, and/or tiltable relative to the robot body. The robot body, head 102, chest/abdomen 103, and any other limbs are also each manufactured via methods for 3D printing.

The interior of the machine further comprises at least one waste disposal tank 114, which accepts all waste resulting from the process of juice making performed by the robot manipulator arms (including but not limited to skin, seeds/pits, and spilled product).

The finished juice product is placed by the manipulator arm(s) on a platform 115 which then descends from a level of the robot downward to a level of the beverage dispending window 116 and consumer. The exterior of the vending machine comprises the beverage dispensing window 116 which opens and closes via a door such that the consumer may receive their finished juice product 117.

The exterior of the vending machine further comprises a means for receiving and accepting orders and payment 118 (e.g., a screen, a screen with keys). The means for receiving and accepting orders and payment 118 allows a consumer to place an order by selecting a juice product, and it may also be configured to receive contactless payment. The means may comprise a touch screen monitor which provides a consumer the ability to select a desired product and to place an order.

Via the means for receiving and accepting orders 118, the consumer may order a custom version of a juice product, based on any proportion and combination of available produce in the machine. Furthermore, the software connected to the machine allows for a correspondence between a consumer and the robot outside of the means for receiving and accepting orders and payment. For example, the consumer may speak a question to the robot and the robot is able to respond. Such correspondence may be limited to simple conversation and may not relate to the ordering of juice product; however, the correspondence allows for additional entertainment to the consumer.

In addition to the mechanism for making the juice products, the machine comprises a control system 119, a power supply 120, a computer with a processor 104, a cash acceptor 123, a fiscal data recorder 121, and a means for connecting to the internet 122.

The software developed for the machine synchronizes the apparatus for making juice products and allows for the setting of particular algorithms and programs for the entire machine in order to obtain products of various combinations, flavors, and sizes. The software particularly controls the manipulator arms' 101 movements while forming the desired product.

The control system 119 of the device can be controlled remotely, in order to switch the machine on or off, add additional algorithms for creation of new combinations and products, and otherwise control the functionality of the device.

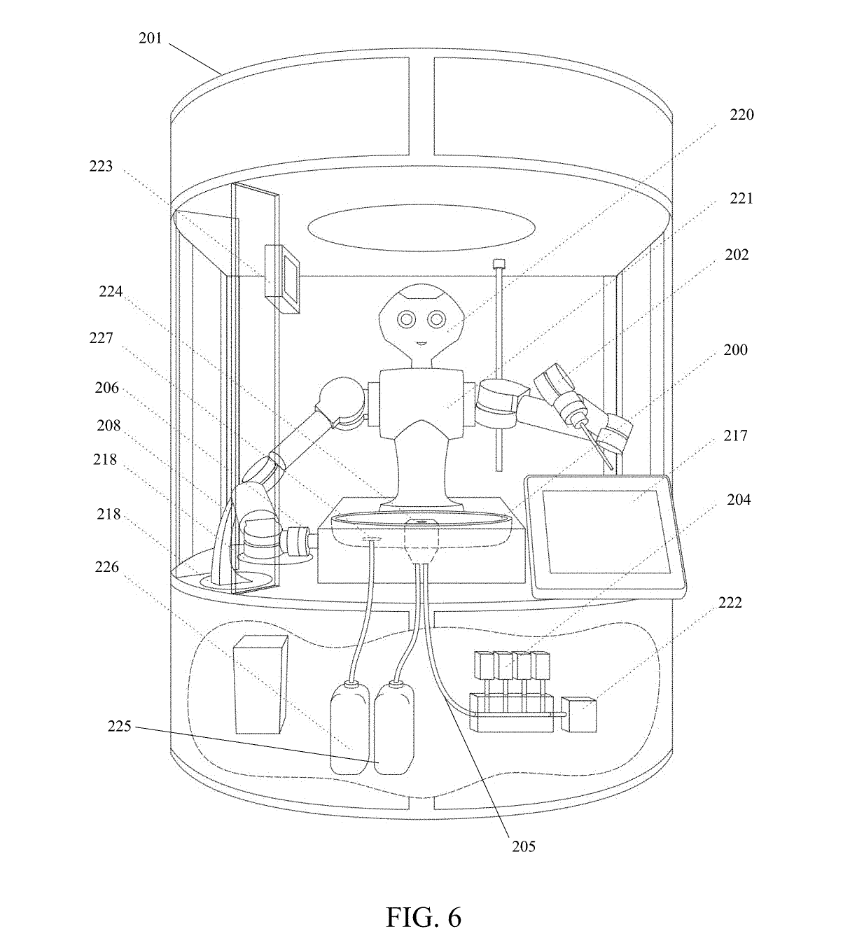

The machine comprises a visual design with music and video support, both inside and outside. The machine is available in various shapes and sizes. The interior and exterior parts comprise screens showing various videos (not shown in FIG. 1, see FIG. 6). The robotic manipulator arms 101 (and any attached robot with head 102 and a body 103), are able to move, pronounce words and make sounds, make various dancing movements, communicate with a consumer, and provide other entertainment for an audience of consumers.

Procedures for making specific juice products are also disclosed herein.

Furthermore, it is possible to create a juice product with a third non-produce ingredient, such as milk, protein, or sugar. Additional storing tanks for each such ingredient are implemented within such embodiments of the machine.

Upon completion of the desired juice product, the finished product 117 is issued to the consumer via an output window 116 (dispensing window) in the machine.

The vending machine further comprises an automatic cleaning system 124, wherein a pump pumps water into each used juicer after every juice product is produced. All waste from the cleaning process flows into a waste tank 114 or directly to the sewer.

The vending machine further comprises at least one water tank 125 for storing clean water for use by the automatic cleaning system. If a sewer is accessible, a single water waste tank 126 is required for immediate storage of waste from the automatic cleaning system. If no sewer is accessible, at least 2 water waste tanks should be installed within the machine.

Each peeler/peeling device 108 may be equipped with a waste storage tank 114, or alternatively, a single waste tank 114 can be accessible via an opening directly under each peeler 108. In this manner, after each peeling process, the waste of the process may be sent to the waste storage tank via each such opening.

The vending machine is further equipped with a temperature sensor system 127, a capacity sensor system 128, and a humidity sensor system 129. Temperature sensors are used to detect and maintain the temperature of the fruits and vegetables (it is noted that particular fruits/vegetables require different storing temperatures, and thus the temperature sensors are configured with processors based on a specific fruit/vegetable). Capacity sensors are used to detect various levels of contents within the storing/waste tanks throughout the machine (for example, the level of remaining stored produce in each storage tank, the fullness of the waste tank(s), the fullness of the clean water tank, the number of remaining juice containers within each dispenser (e.g., glasses, cups)).

The vending machine may further be equipped with an autonomous battery, such that in the event of a power outage, the autonomous battery will automatically turn on to maintain power to the machine.

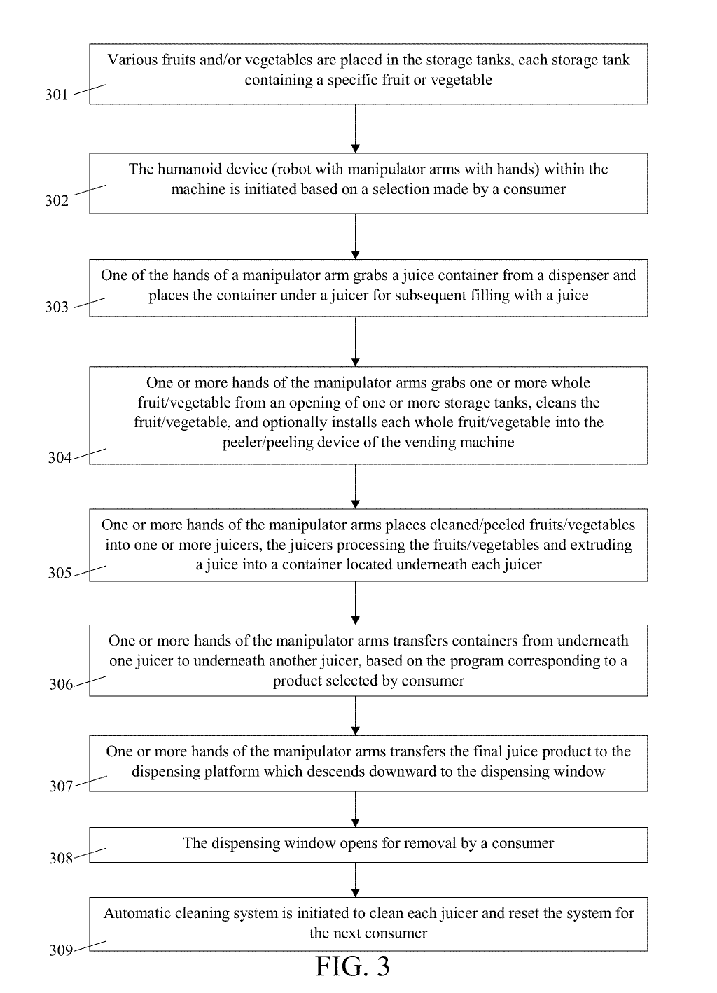

The method of the present invention can be described as follows (See FIG. 3):

(1) Various fruits and/or vegetables are placed in the storage tanks, each storage tank containing a specific fruit or vegetable 301 (e.g., apple, orange, grapefruit, pear, carrot, beet, lemon, pomegranate, etc.).

(2) A humanoid device (robot with manipulator arms with hands) is initiated 302 to perform the main functional steps in the process of making the juice product ordered by a consumer, the steps comprising:

(3) One of the hands of a manipulator arm grabs a juice container from a dispenser and places the container under a juicer for subsequent filling with a juice 303.

(4) One of the hands of a manipulator arm grabs one or more whole fruit/vegetable from an opening of one or more storage tanks, cleans the fruit/vegetable, and installs each whole fruit/vegetable into the peeler/peeling device of the vending machine 304. This peeling step is optional depending on the fruit/vegetable (some fruits/vegetables do not require peeling, and some embodiments of the invention comprise already peeled fruit/vegetables within the storage tanks).

(5) Once the fruit/vegetable is peeled, the manipulator arm(s) transfers the produce from the peeler to one of the juicers, wherein the juicers process the fruits/vegetables placed within them and extrude a juice product into the container positioned below them 305. Various fruits may thus be placed into different juicers, wherein each juicer performs a particular type of blending, crushing, mixing, or juicing. The manipulator arms are able to move the beverage container from underneath one juicer to underneath another juicer and thus mix the product of each juicer according to any particular order based on a program 306. In other embodiments, juice containers may be placed under all juicers of the machine, wherein the robot arms combine the extruded juices in various combinations. Several iterations may be made by the manipulator arms and juicers until a final product is created.

(6) Once the final juice product is completed, the manipulator arm takes the filled beverage container and transfers it to the dispensing platform which descends downward to the dispensing window 307. Once the platform reaches the dispending window, the door of the dispensing window opens and the container may be removed by the consumer 308.

(7) The automatic cleaning system is initiated once the user removes the juice product in container, wherein the juicers, hands, arms, and any other tools are cleaned with water via a pump, and wherein waste is transferred to a waste tank or directly into the sewer 309.

Thus, the present invention comprises an apparatus for making and vending a juice product, the apparatus comprising a housing, said housing comprising walls, said walls comprising solid transparent surfaces forming a visible open interior of the apparatus, wherein one wall of said housing comprises a means for accessing the interior of the apparatus, one or more storing tanks for storing produce, one or more container dispensers, said dispensers holding unused juice containers, one or more juicers, each juicer being removable and replaceable, one or more peeling devices, each peeling device being removeable and replaceable, one or more waste disposal tanks, a descending platform, a dispensing window, a means for receiving orders and accepting payment, and one or more robotic manipulator arms, each robotic manipulator arm comprising a robotic hand, wherein each robotic manipulator arm comprising a robotic hand is controlled by a program for a product ordered by a consumer, the program causing the one or more robotic manipulator arms to automatically transfer produce from the one or more storing tanks to the one or more juicers, transfer one or more containers from the one or more container dispensers to a position underneath the one or more juicers, combine juices extruded by the one or more juicers according to the program, and transfer a final juice product to the descending platform, wherein the descending platform with the final juice product moves to the dispensing window, wherein the dispensing window opens such that the consumer may receive the final juice product.

In some aspects, the apparatus comprises at least two robotic manipulator arms, each arm comprising a robotic hand.

In some aspects, the program for a product ordered by a consumer further causes the one or more robotic manipulator arms to automatically transfer produce from the one or more storing tanks to the one or more peeling devices prior to transferring the produce to the one or more juicers.

In some aspects, the means for receiving orders and accepting payments comprises a touch screen.

In some aspects, the means for receiving orders and accepting payments is configured to receive contactless payment.

In some aspects, the one or more peeling devices are positioned directly above the one or more waste disposal tanks.

In some aspects, the one or more robotic manipulator arms are coupled to a body, the body comprising a head and a chest. In some aspects, the head further comprises one or more electronic displays.

In some aspects, the apparatus comprises up to 10 storing tanks.

In some aspects, the apparatus further comprises an automatic cleaning system, the automatic cleaning system comprising a water tank and a pump, said pump extruding water from said water tank into each juicer after each final juice product is delivered to a consumer, wherein waste from the automatic cleaning system is sent to a water waste tank.

In some aspects, the apparatus further comprises a temperature sensor system comprising temperature sensors, each temperature sensor being configured according to a given storing tank containing a given produce.

In some aspects, the apparatus further comprises a humidity sensor system.

In some aspects, the apparatus further comprises a capacity sensor system.

The apparatus of claim 1, comprising two or more juicers, each juicer performing a unique type of produce processing.

Also disclosed is a method for making and vending a juice product, the method comprising providing one or more robotic manipulator arms, each robotic manipulator arm comprising a robotic hand, wherein each robotic manipulator arm comprising a robotic hand is controlled by a program for a product ordered by a consumer via a means for receiving orders and accepting payment, the program causing the one or more robotic manipulator arms to automatically transfer produce from one or more storing tanks to one or more juicers, transfer one or more containers from one or more container dispensers to a position underneath the one or more juicers, combine juices extruded by the one or more juicers according to the program, and transfer a final juice product to a descending platform, wherein the descending platform with the final juice product moves the final juice product to a dispensing window, wherein the dispensing window opens such that the consumer may receive the final juice product.

In some aspects, the program for a product ordered by a consumer further causes the one or more robotic manipulator arms to automatically transfer produce from the one or more storing tanks to one or more peeling devices prior to transferring the produce to the one or more juicers.

In some aspects, the method further comprises cleaning the one or more juicers after a final juice product is delivered to a consumer via an automatic cleaning system, the automatic cleaning system comprising a water tank and a pump, said pump extruding water from said water tank into each juicer after each final juice product is delivered to a consumer, wherein waste from the automatic cleaning system is sent to one or more water waste tanks.

In some aspects, the method further comprises maintaining a temperature within the one or more storing tanks via a temperature sensor system, said temperature corresponding to a produce within the one or more storing tanks.

In some aspects, the method further comprises maintaining a humidity within the one or more storing tanks via a humidity sensor system, said humidity corresponding to a produce within the one or more storing tanks.

In some aspects, the method comprises providing at least two robotic manipulator arms, each arm comprising a robotic hand.

Cotton Candy Machine.

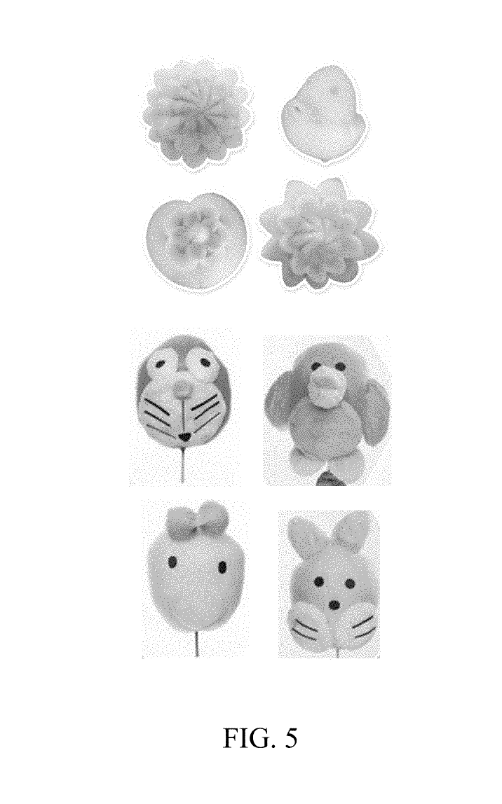

The present invention also comprises an automated machine or process for the production and vending of cotton candy of various shapes and sizes. Exemplary shapes of cotton candy include but are not limited to animals such as bears, piglets, dinosaurs, and cats, hearts, flowers, and cartoon characters (See FIG. 5). It is noted that colors are relevant in this Figure and thus the Figure is presented in color. The cotton candy machine produces cotton candy products based on sugars having various colors, the distinctiveness of which is not visible in black and white.

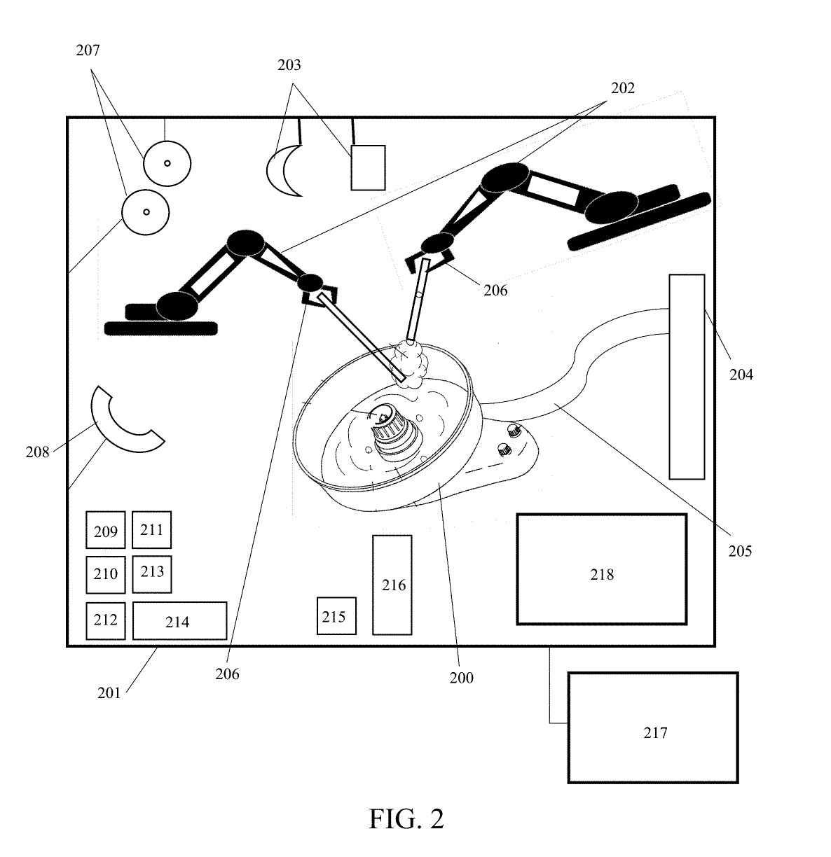

Referring to FIGS. 2 and 6 (showing two different embodiments), the working mechanism of the device comprises an apparatus for making cotton candy 200. The apparatus may be of any shape and size and may have any technical features. Sugar is fed upwards out of the apparatus. The working mechanism further comprises one or more robotic manipulator arms 202 which are used to create (i.e., wind) cotton candy of varying shapes and sizes. The robotic manipulator arms simulate the action of human arms and hands, as if a human was performing the procedure of making cotton candy. The robotic manipulator arm(s) may be fixed to the device and/or designed to resemble a robot with a head 220, body 221, and legs (similar to the juice product machine). The apparatus for making cotton candy 200 and the robotic manipulator arm(s) are positioned inside a housing 201 which forms the outside of the vending machine.

One or more manipulator arms 202 (preferably two) may be used to perform the functions associated with the preparation of cotton candy in various shapes and designs. The hands or other means for holding sticks 206 of the manipulator arms have from 2-7 degrees of freedom, allowing for many movement of the stick, as described herein. The load capacity of each hand or means for holding sticks of the manipulator arms is up to three kilograms. The sticks are available to the robotic arms via a stick dispenser 223. The manipulator arms are capable of producing a cotton candy product in 30 to 120 seconds, depending on the complexity of the design desired.

Additionally, the device may comprise one or more press molds 203 of various shapes and sizes which are used by the robotic arms to form various denser cotton candy designs by inserting a spun portion of cotton candy into the press mold. These pressed designs are then combined with other portions to form a specific shape or figure.

The press molds and other means for shaping the cotton candy design may comprise various shapes, such as square, rectangle, oval, circle, triangle, and a flattening mold. The material of the means for shaping comprises polyurethane or other materials which provide for a non-adhesive surface which does not cling to the cotton candy.

A portion of the vending machine (upper or lower) comprises a section with openings for the placement of cartridges 204. Preferably, the cartridges are located below the cotton candy-making apparatus and hidden from the consumer's view. The cartridges contain sugars of different colors and/or different flavors. The total capacity of the cartridges may range from 0.1 to 100 kg of sugar. A tube or multiple tubes 205 connect the cartridges and the heating portion of the machine, such that different sugars may be send to the heating portion of the machine based on a signal or instruction received. Via air pumps 222 within the tube(s), sugars of varying color are fed to the head 224 of the cotton candy-making apparatus 200 from the cartridges, such that the sugar is fed portion by portion and successively. The type of sugar fed and the portion amount is controlled by the control system (described below). The cartridges 204 themselves are produced via a 3D printing process employing polymeric materials.

The manipulator arms 202 are equipped with a means for holding a stick 206 onto which the cotton candy is spun. The following actions are enabled via the means for holding a stick 206, which comprises between two and seven degree of freedom: (1) stick rotation around its axis (for winding up cotton candy on the stick), (2) stick movement along it axis (enabling the winding up of structures of complex shape), (3) movement of the stick upward or downward (for winding a desired shape), (4) movement of one portion of the stick relative to another portion (e.g., flipping or twisting diagonally), (5) stick rotation around its axis at a given angle (to press and shape the cotton candy), and (6) any combination thereof. In essence, the manipulator arms can perform any action needed to rotate or move the sticks in order to form any shape or design of cotton candy.

The means for holding a stick 206 may comprise a clamping mechanism with two or more digits (moveable extensions, similar to fingers, as shown in FIG. 2). In other embodiments, the means for holding a stick may comprise clamping jaws which are situated within a cylinder (as shown in FIG. 6), said clamping jaws being moveable further towards a center of the cylinder, wherein a stick is inserted into the cylinder. The cylinder with clamping jaws is attached to the end of each robotic manipulator arm. In this manner (similar to the insertion of a drill bit into a drill), the clamping jaws grasp the stick in a surrounding manner such that the stick is fixed within the cylinder. The means for holding a stick may comprise various polymeric materials and/or metal materials.

The device further comprises press molds 203, clamping mechanisms, and stretching mechanisms for making cotton candy products of various shapes. These mechanisms may comprise the following exemplary forms: (1) various two-dimensional shapes, (2) various 3-dimensional shapes, (3) clamping roller (for condensing/stretching) 207, (4) clamp with a pulling mechanism (for stretching)).

The device further comprises a cotton candy remover or holder 208, such that the robot arms/hands do not have to hold the finished product. The remover 208 is designed for removing cotton candy from one of the sticks and pasting it into a desired location of the main design (located on another stick). If it is a holder, then one of the arms places the portion of the finished product onto the holder. Individual parts are thus created and attached to the final product. Press molds 203 may also be used to mold the removed portion prior to fixation on the final design. A secondary robotic manipulator arm attaches separate portions to corresponding areas on the primary robotic manipulator arm (or holder) containing the stick with the final product, thus forming a visual figure or design.

In addition to the mechanism for making the cotton candy product, the machine comprises a control system 209, a power supply 210, a computer with a processor 211, a cash acceptor 214, a fiscal data recorder 212, and a means for connecting to the internet 213.

The machine further comprises built-in humidity/moisture sensors 215 and an air humidification system 216. The air humidification system comprises an air humidifier, the moisture sensors which are installed inside the machine, both of which are coupled to the control system (or a separate control unit for the air humidification itself). The humidity/moisture sensors allow for continuous monitoring of the operating humidity level and thus maintenance of the required level of humidity optimal for making cotton candy.

The vending machine further comprises an automatic cleaning system, wherein a pump pumps water into the cotton candy making apparatus after a product is produced. All waste from the cleaning process flows into a waste tank or directly to the sewer.

The vending machine further comprises at least one water tank 225 for storing clean water for use by the automatic cleaning system. If a sewer is accessible, a single water waste tank 226 is required for immediate storage of waste from the automatic cleaning system, which is received via the water waste opening 226. If no sewer is accessible, at least 2 water waste tanks should be installed within the machine.

The software developed for the machine synchronizes the apparatus for making cotton candy and allows for the setting of particular algorithms and programs for the entire machine in order to obtain products of various shapes, tastes, and designs. The software particularly controls the manipulator arms' 202 movements while forming the desired product.

The machine further comprises a touch screen monitor 217 which provides a consumer the ability to select a desired shape and place an order. Furthermore, via the touch screen monitor, a consumer is able to draw or otherwise create a custom design for a cotton candy product, which the machine is able to reproduce. In essence, the drawing provided by a consumer is translated into blueprints for 3-D printing of the design and translated to the robotic manipulator arms via the control system.

Upon completion of the desired design, the product is issued to the consumer via an output/dispensing window 218 in the machine.

Furthermore, the software connected to the machine allows for a correspondence between a consumer and the robot outside of any means for receiving and accepting orders and payment (i.e., the touch screen monitor). For example, the consumer may speak a question to the robot and the robot is able to respond. Such correspondence may be limited to simple conversation and may not relate to the ordering of cotton candy product; however, the correspondence allows for additional entertainment to the consumer.

The control system 209 of the device can be controlled remotely, in order to switch the machine on or off, add additional algorithms for creation of new shapes and products, and otherwise control the functionality of the device.

The machine comprises a visual design with music and video support, both inside and outside. The machine is available in various shapes and sizes. The interior and exterior parts may comprise screens showing various videos. The robotic manipulator arms 202 (and any attached robot with head and a body), are able to move, pronounce words and make sounds, make various dancing movements, and provide other entertainment for an audience of consumers. The head of the body of the robot may comprise a screen on which a virtual face of a human or robot is displayed. In other embodiments, the screen comprises a video and/or photograph display.

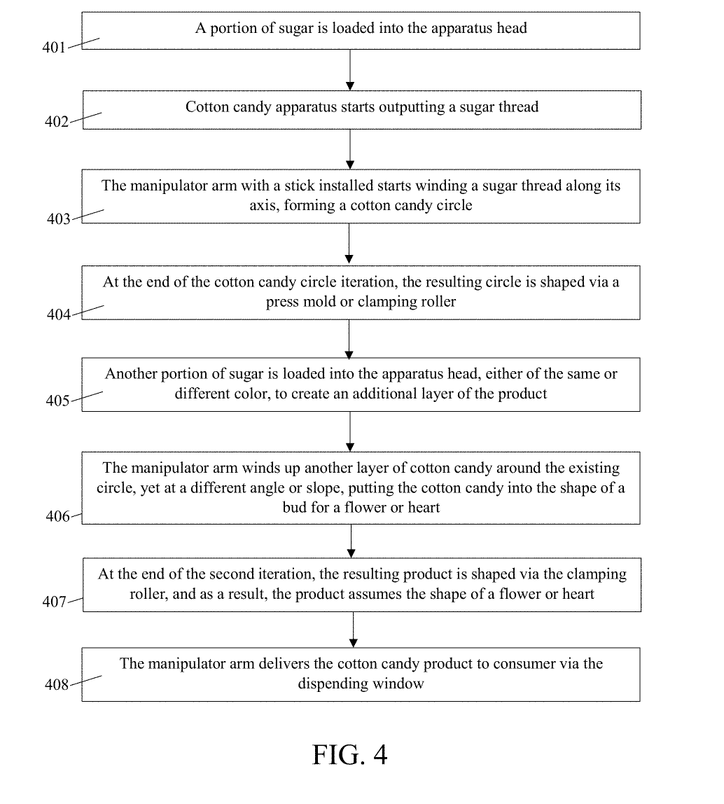

Particular procedures for making specific designs are also disclosed herein. For example, the following procedure is used by the machine, via the control system 209 and one of its algorithms, to produce one design of a heart or a flower (See FIG. 4):

(1) A portion of sugar is loaded into the apparatus head 401.

(2) Cotton candy apparatus starts outputting a sugar thread 402.

(3) The manipulator arm with a stick installed starts winding a sugar thread along its axis, forming a cotton candy circle 403.

(4) After the end of this iteration, the resulting circle is shaped via a press mold or clamping roller, wherein the press mold or clamping roller is moved towards the cotton candy product or vice versa via the manipulator arm 404.

(5) Another portion of sugar is loaded into the apparatus head, either of the same or different color, to create an additional layer of the product 405.

(6) The manipulator arm winds up another layer of cotton candy around the existing circle, yet at a different angle or slope, putting the cotton candy into the shape of a bud for a flower or heart 406.

(7) After the end of this iteration, the resulting product is shaped via the clamping roller. As a result, the product assumes the shape of a flower or heart 407.

(8) The manipulator arm delivers the cotton candy product to the consumer via the dispensing window of the machine 408.

The number of iterations described above may vary between 1 and 30, making the end product multi-layered and multi-colored, if desired.

The description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What is claimed is:

1. An apparatus for making and vending a juice product, comprising:
a housing, said housing comprising walls, said walls comprising solid transparent surfaces forming a visible open interior of the apparatus, wherein one wall of said housing comprises a means for accessing the interior of the apparatus,
one or more storing tanks for storing produce,
one or more container dispensers, said dispensers holding unused juice containers,
one or more juicers, each juicer being removable and replaceable,
one or more peeling devices, each peeling device being removeable and replaceable,
one or more waste disposal tanks,
a descending platform,
a dispensing window,
a means for receiving orders and accepting payment, and
one or more robotic manipulator arms, each robotic manipulator arm comprising a robotic hand, wherein each robotic manipulator arm comprising a robotic hand is controlled by a program for a product ordered by a consumer, the program causing the one or more robotic manipulator arms to automatically:
transfer produce from the one or more storing tanks to the one or more juicers,
transfer one or more containers from the one or more container dispensers to a position underneath the one or more juicers,
combine juices extruded by the one or more juicers according to the program, and
transfer a final juice product to the descending platform, wherein the descending platform with the final juice product moves to the dispensing window, wherein the dispensing window opens such that the consumer may receive the final juice product.

2. The apparatus of claim 1, comprising at least two robotic manipulator arms, each arm comprising a robotic hand.

3. The apparatus of claim 1, wherein the program for a product ordered by a consumer further causes the one or more robotic manipulator arms to automatically transfer produce from the one or more storing tanks to the one or more peeling devices prior to transferring the produce to the one or more juicers.

4. The apparatus of claim 1, wherein the means for receiving orders and accepting payments comprises a touch screen.

5. The apparatus of claim 1, wherein the means for receiving orders and accepting payments is configured to receive contactless payment.

6. The apparatus of claim 1, wherein the one or more peeling devices are positioned directly above the one or more waste disposal tanks.

7. The apparatus of claim 1, wherein the one or more robotic manipulator arms are coupled to a body, the body comprising a head and a chest.

8. The apparatus of claim 7, wherein the head further comprises one or more electronic displays.

9. The apparatus of claim 1, comprising up to 10 storing tanks.

10. The apparatus of claim 1, further comprising an automatic cleaning system, the automatic cleaning system comprising a water tank and a pump, said pump extruding water from said water tank into each juicer after each final juice product is delivered to a consumer, wherein waste from the automatic cleaning system is sent to a water waste tank.

11. The apparatus of claim 1, further comprising a temperature sensor system comprising temperature sensors, each temperature sensor being configured according to a given storing tank containing a given produce.

12. The apparatus of claim 1, further comprising a humidity sensor system.

13. The apparatus of claim 1, further comprising a capacity sensor system.

14. The apparatus of claim 1, comprising two or more juicers, each juicer performing a unique type of produce processing.

15. A method for making and vending a juice product, the method comprising:
providing one or more robotic manipulator arms, each robotic manipulator arm comprising a robotic hand, wherein each robotic manipulator arm comprising a robotic hand is controlled by a program for a product ordered by a consumer via a means for receiving orders and accepting payment, the program causing the one or more robotic manipulator arms to automatically:
transfer produce from one or more storing tanks to one or more juicers,
transfer one or more containers from one or more container dispensers to a position underneath the one or more juicers,
combine juices extruded by the one or more juicers according to the program, and
transfer a final juice product to a descending platform, wherein the descending platform with the final juice product moves the final juice product to a dispensing window, wherein the dispensing window opens such that the consumer may receive the final juice product.

16. The method of claim 15, wherein the program for a product ordered by a consumer further causes the one or more robotic manipulator arms to automatically transfer produce from the one or more storing tanks to one or more peeling devices prior to transferring the produce to the one or more juicers.

17. The method of claim 15, further comprising cleaning the one or more juicers after a final juice product is delivered to a consumer via an automatic cleaning system, the automatic cleaning system comprising a water tank and a pump, said pump extruding water from said water tank into each juicer after each final juice product is delivered to a consumer, wherein waste from the automatic cleaning system is sent to one or more water waste tanks.

18. The method of claim 15, further comprising maintaining a temperature within the one or more storing tanks via a temperature sensor system, said temperature corresponding to a produce within the one or more storing tanks.

19. The method of claim 15, further comprising maintaining a humidity within the one or more storing tanks via a humidity sensor system, said humidity corresponding to a produce within the one or more storing tanks.

20. The method of claim 15, comprising providing at least two robotic manipulator arms, each arm comprising a robotic hand.
